(19) United States
(12) Patent Application Publication
(10) Pub. No.: US 2004/0064077 A1
(43) Pub. Date: Apr. 1, 2004

(54) Method and apparatus for promoting circulation of blood

(76) Inventor: Richard S. Dillon, Ardmore, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/677,463

(22) Filed: Sep. 30, 2003

Related U.S. Application Data
(60) Provisional application No. 60/415,232, filed on Oct. 1, 2002.

(51) Int. Cl. A61H 23/04

(52) U.S. Cl. 601/152; 601/151

(57) ABSTRACT

An apparatus and method for enhancing blood circulation are used to apply external pressure to a patient's extremity to improve blood circulation. The apparatus includes a rigid enclosure and an inflatable flexible enclosure that extends around the patient's extremity. A source of compressed gas discharges gas into the flexible enclosure to apply external pressure to the extremity. A monitor and pilot control valve regulate the flow of compressed gas into the flexible enclosure. A pressure sensor, servomechanism and adjustable control valve adjust the flow of gas to maintain preset pressure peaks in the flexible enclosure. A pressure storage tank is connected with the source of compressed gas to provide a reserve of compressed gas at a desired operating pressure.

### RELATED APPLICATIONS

This application claims the benefit of the filing date of U.S. Provisional Application No. 60/415,232, filed Oct. 1, 2002, the entire disclosure of which is incorporated herein by reference.

### BACKGROUND OF THE INVENTION

In the present state of the art, apparatuses are used to artificially promote blood circulation in patients suffering from diseases and ailments. In one method, apparatuses are used to apply and remove pressure from a patient's extremity. For example, a patient's leg may be enclosed in a flexible air bag which is housed in a rigid enclosure. The air bag is inflated with compressed air to apply pressure on the leg, and subsequently deflated to remove pressure from the leg. Intermittent pressure is applied to the leg at specific intervals controlled by a pilot control valve or other type of regulator. Application of pressure on the leg in synchronization with arterial pulse from the heart has shown many positive effects, including but not limited to enhanced blood flow into the leg and enhanced pumping of blood through the heart.

Blood circulation is enhanced by applying pressure pulses to the leg at a time in the arterial pulse cycle after the pulse volume has entered the leg. The additional pressure applied to the leg reinforces the pulse of blood to force blood into the leg. The apparatus also relieves the applied pressure at a time in the pulse cycle to enable the next pulse to introduce blood into the leg. The application and removal of pressure to the leg reinforces blood flow into the leg and enhances the return of blood from the leg to the heart. A more detailed description of this process is disclosed in U.S. Pat. No. 4,343,302 issued to the present inventor.

To improve circulation in the leg, the apparatus should be set to provide a proper terminal pressure in the air bag and apply a consistent amount of external pressure to the leg during each cycle. Variables associated with the apparatus can affect terminal pressure in the air bag. For instance, changes in how an air bag collapses from one cycle to the next can result in increases or decreases in bag pressure when pressurized. The extent of collapse at the end of one cycle directly affects the bag pressure when the bag is pressurized in the following cycle. In particular, when an air bag deflates and collapses, the flow regulator must allow enough compressed air into the bag during the next cycle to make up for the volume of collapse. If the amount of collapse decreases from one cycle to the next, less air is required to make up for the collapse. Present regulators, however, are not set to detect a decrease in collapse volume. As a result, the air bag may be over-pressurized, triggering automatic shut off of the apparatus to avoid harming the patient. If the amount of bag collapse increases from one cycle to the next, more air is required in each cycle to make up for the increased collapse. Again, the regulator is not configured to detect a change in the collapse volume in the air bag. As a result, the air bag may be under-pressurized over time, requiring manual adjustment of the flow regulator. The amount of collapse in an air bag may change in response to many factors. For example, the amount of collapse may decrease in response to electrostatic forces that develop on the exterior of the bag. The amount of collapse may also change when the frequency of inflation cycles changes.

Proper application of pressure is also affected by the source of air pressure, air hoses, piping, and fittings used between the source of air pressure and the air bag. Where a compressor is used as the source of air pressure, the compressor may not provide a consistent line pressure, varying the amount of air that inflates the air bag. This can result in over-pressurization or under-pressurization of the air bag. In addition, air flow characteristics in the piping and valve assembly can affect the pressure entering the air bag. Some connections proximal to the valve assembly have abrupt transitions or obstructions that significantly reduce line pressure as it enters the valve assembly. Constrictions in the air line proximal to wall air outlets may also reduce line pressure. Air pressure in the valve assembly may drop to an unsatisfactory level if there are constrictions or obstructions in the air line proximal to the valve assembly.

Where line pressure is supplied by a wall source, as is the case in some hospital rooms, the wall source and associated air hoses may not deliver sufficient air flow to properly inflate the air bag. Many times, the air hoses and fittings have small lumens. In other cases, the air hoses or wall source may have constrictions. For example, filter screens used in the wall source may be clogged with debris that impedes air flow. Because of these limitations, existing wall sources frequently fail to provide adequate pressure needed to rapidly inflate the air bag during an inflation cycle. As a result, there is a need for an apparatus that monitors conditions in the air bag and supplies a sufficient amount of air flow for each inflation cycle.

### SUMMARY OF THE INVENTION

Based on the foregoing, an apparatus in accordance with the present invention includes a rigid enclosure adapted to enclose a patient's extremity, such as a patient's leg. The rigid enclosure includes an opening adapted to receive the patient's leg into the rigid enclosure. The rigid enclosure also includes a flexible enclosure within the rigid enclosure which extends around the patient's leg when the leg is inserted into the rigid enclosure. A source of compressed gas connects with the flexible enclosure and discharges gas into the flexible enclosure to inflate the flexible enclosure. A pilot control valve connects between the source of compressed gas and the flexible enclosure. The pilot control valve is operable in an open position to permit the flow of gas into the flexible enclosure, and a closed position to prevent the flow of gas into the flexible enclosure.

A monitor senses the patient's arterial pulse and sends a signal to the pilot control valve to open the pilot control valve after the arterial pulse carries blood into the patient's leg. When the pilot control valve is opened, the flexible enclosure inflates with gas, applying external pressure to the patient's leg. The external pressure applied to the leg disseminates the arterial pulse volume around the leg and enhances removal of blood out of the leg to improve circulation.

In one embodiment of the invention, an automatically adjustable control valve regulates the flow of gas into the flexible enclosure. The adjustable control valve may be connected at various points between the source of compressed gas and the flexible enclosure. For example, the adjustable control valve may be connected between the pilot control valve and the flexible enclosure. A pressure sensor is connected with the flexible enclosure to measure the internal pressure in the flexible enclosure. The sensor sends a signal to a servomechanism based on the measured pressure in the flexible enclosure. Based on this pressure measurement, the servomechanism may send an output signal to the adjustable control valve to increase or decrease the flow of compressed gas so that the terminal pressure in the flexible enclosure is monitored and maintained within a preferred range.

The apparatus may include an optional pressure storage tank that connects with the source of compressed gas to provide a reserve of compressed gas at a desired operating pressure. By storing a large volume of compressed gas at the desired operating pressure, a high flow rate of gas into the flexible enclosure can be sustained during each inflation cycle.

### DESCRIPTION OF THE DRAWINGS

The preceding summary and the following description will be better understood when read in conjunction with the figures in which:

FIG. 1 is a fragmented schematic view of an apparatus in accordance with the present invention.

FIG. 2 is a fragmented schematic view of an alternate embodiment of an apparatus in accordance with the present invention.

### DETAILED DESCRIPTION OF THE PREFERRED EMBODIMENT

The present invention provides a method and apparatus for improving and promoting blood circulation in a patient. The apparatus applies intermittent pressure to an extremity, such as a patient's leg, to enhance blood circulation. The present invention may be used in conjunction with the apparatuses and methods taught in U.S. Pat. Nos. 3,961,625, 4,269,175, 4,343,302 and/or 4,590,925, the entire contents of which are incorporated by reference herein.

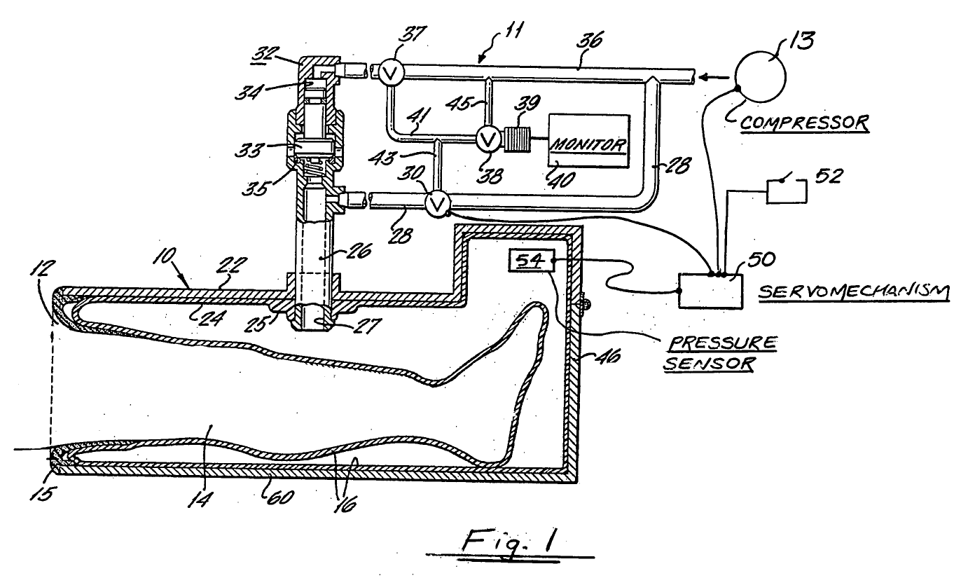

Referring to FIG. 1, an apparatus in accordance with the present invention comprises a rigid enclosure 10 having an opening 12 for insertion of an extremity. The present invention may be used on various parts of the body, including but not limited to a patient's arm, lower calf, or the patient's entire leg. In FIG. 1, a patient's leg 14 is shown inserted in the rigid enclosure 10. An inflatable flexible enclosure or bag 16 surrounds the leg 14 inside the rigid enclosure 10. A source of compressed gas is connected to the flexible enclosure 16 to supply compressed gas to the flexible enclosure. A variety of sources of compressed gas can be used with the apparatus, including but not limited to an air compressor or a wall source of compressed gas. In addition, a variety of gases may be used to inflate the flexible enclosure 16. In FIG. 1, a compressor 13 is connected to the flexible enclosure 16 to supply compressed air to the flexible enclosure.

The compressor 13 and flexible enclosure 16 are connected by a valve assembly 11. The valve assembly 11 may have various arrangements and comprise one or more valves, including but not limited to electric or air-operated valves. The valve assembly 11 is operable in an open setting and closed setting to permit pressurization and de-pressurization of the flexible enclosure 16. A monitor 40 is operable to detect the patient's heartbeat and send a signal to the valve assembly 11 to open one or more valves in the valve assembly. As the flexible enclosure 16 inflates with compressed gas, the flexible enclosure applies inward pressure on the patient's leg to enhance blood circulation in the leg.

The apparatus will now be described in greater detail. The rigid enclosure 10 may be constructed in a variety of ways to enclose the patient's leg. Preferably, the rigid enclosure 10 is formed of an upper section comprising the top and upper sides of the rigid enclosure, and a lower section comprising the lower sides and bottom of the rigid enclosure. The upper and lower sections are preferably connected by a buckle or other releasable mechanism that permits the upper section to be disconnected and removed from the lower section. In this arrangement, the upper section can be removed from the lower section to permit insertion of the leg through the top of the rigid enclosure 10, and removal of the leg from the top of the rigid enclosure. This configuration also permits the upper section to be detachably connected with the lower section in a closed position around the leg. The upper and lower sections preferably have a latch or lock that secures the sections in the closed position. The rigid enclosure 10 has an open end to permit insertion of the patient's leg into the rigid enclosure. The open end preferably includes an adjustable strap 15 that extends circumferentially around the flexible enclosure 16 and patient's leg when the patient's leg is inserted into the rigid enclosure 10. The adjustable strap 15 is configured to secure the end of the flexible enclosure 16 to a chosen position around the patient's leg. In this arrangement, the strap 15 substantially prevents the flexible enclosure 16 from being blown out of the rigid enclosure 10 during inflation of the flexible enclosure. A variety of strap materials and fasteners may be used to form the strap, including but not limited to a nylon strap with hook and loop fasteners.

The upper section of the enclosure 10 includes an upper wall 22 which extends above the patient's leg. An aperture 27 extends through the upper wall 22 and connects with the flexible enclosure 16. An air inlet conduit 26 extends through the aperture 27 and into the flexible enclosure 16. The air inlet conduit 26 is preferably secured to the interior of the flexible enclosure 16 by an elastic sealing member 25. The valve assembly 11 includes an air supply conduit 28 that connects between the compressor 13 and the air inlet conduit 26.

The air inlet conduit 26 is connected with an air outlet valve 32 operable to release pressure from the flexible enclosure 16. The air outlet valve 32 has a cylindrical valve element 33 which is biased upwardly by a spring. Valve element 33 is adapted for vertical movement in a cylindrical chamber 34, and is displaceable between an open position and a closed position. In the open position, the element permits compressed air in the flexible enclosure 16 to escape through openings in the sidewall of the air outlet valve 32. In the closed position, the valve element 33 retains compressed air in the air inlet conduit and flexible enclosure. In this arrangement, the valve element 33 is operable in the open position during deflation of the flexible enclosure 16, and operable in the closed position during inflation of the flexible enclosure.

Compressed air enters the valve assembly through an air line 36. The air line 36 connects with the air outlet valve 32 and the air supply line 28. A pair of quick-acting air operated valves are connected in the valve assembly to control the flow of compressed air to the air outlet valve 32 and air inlet conduit 26. Specifically, an air-operated adjustable control valve 30 is connected with the air supply line 28 to control the flow of compressed air to the air inlet line 26. An air-operated release valve 37 is connected with air line 36 and controls the operation of the air outlet valve 32.

The monitor 40 detects the patient's arterial pulse and controls the flow of compressed air into the flexible enclosure 16. The monitor 40 may be a pulse monitor that connects to the patient's leg to detect the patient's pulse through the leg. Alternatively, the monitor 40 may comprise an electrocardiograph (EKG monitor) which is operable to detect the QRS complex in the patient's heart cycle. The apparatus preferably includes an EKG monitor as described in U.S. Pat. No. 5,514,079 issued to the present inventor, the entire disclosure of which is incorporated herein by reference. The EKG monitor 40 computes an average time period between successive QRS complexes and initiates a timing cycle for compressing and decompressing the patient's leg. After detection of a QRS complex and a time delay to account for the travel time of the pulse volume into the leg, the EKG monitor sends an electrical output signal to the valve assembly 11 to release compressed gas into the flexible enclosure.

The valve assembly 11 includes a pilot control valve 38 that regulates the flow of compressed air from line 36 into the flexible enclosure 16 and air outlet valve 32. A connecting line 45 connects air line 36 to the control valve 38. The pilot control valve 38 is operably connected with a solenoid 39 which is configured to open and close the pilot control valve. The EKG monitor 40 is connected with the solenoid 39 and sends an electrical output signal to the solenoid to open the pilot control valve and release compressed gas into the flexible enclosure.

The pilot control valve 38 is connected to the adjustable control valve 30 by a pair of connecting lines 41, 43. When the pilot control valve 38 is open, compressed air passes through the pilot control valve, through connecting lines 41, 43 and into the adjustable control valve 30, causing the adjustable control valve to open. The opening in the control valve 30 is adjustable to control the flow rate of compressed air into the air inlet conduit 26 when the pilot control valve 38 is opened. Preferably, the adjustable control valve 30 is automatically adjusted by a servomechanism 50. The servomechanism 50 is operable to regulate the flow of compressed air through the adjustable control valve 30 and insure that the pressure in the flexible enclosure 16 is constant each time the flexible enclosure is pressurized. The servomechanism 50 automatically adjusts the flow of air that enters the flexible enclosure 16 to account for changes in compressor function, changes in the collapse volume in the flexible enclosure, or other variables that affect terminal pressure in the flexible enclosure.

The servomechanism 50 is connected to a pressure sensor 54 that measures the pressure in the interior of the flexible enclosure 16. The sensor 54 may be positioned at any location suitable for measuring pressure in the flexible enclosure 16. In FIG. 1, the sensor 54 is located in the interior of the flexible enclosure 16. However, the pressure sensor 54 could also be located in the air inlet conduit 26. When the flexible enclosure 16 is inflated, the sensor 54 sends an electrical signal to the servomechanism 50. The signal corresponds to the magnitude of the pressure measured in the flexible enclosure 16. When pressure reaches a desired pressure threshold, the servomechanism 50 may generate an output signal to close the adjustable control valve 30. Alternatively, the sensor 54 may send a signal to the servomechanism 50 to throttle down the adjustable control valve 30 to reduce the flow of compressed air into the flexible enclosure 16. When pressure is below a desired pressure, the sensor 54 may send a signal to the servomechanism 50 to increase the flow through the adjustable control valve 30. In this configuration, the servomechanism 50 and pressure sensor 54 cooperate with the adjustable control valve 30 to adjust air flow and insure that the terminal pressure in the flexible enclosure 16 during each cycle remains relatively constant in successive cycles.

The servomechanism 50 may be electrically connected to other components in the system in order to regulate pressure in the flexible enclosure. For example, the servomechanism 50 may be configured to send a throttling signal to the compressor 13 to increase or decrease the flow rate of air in response to pressure conditions in the flexible enclosure 16. In this arrangement, the flow rate in which compressed gas is pumped into the flexible enclosure can be adjusted for each inflation cycle.

On some occasions, the static line pressure between the compressor 13 and pilot control valve 38 may be at the desired level when the pilot control valve is closed. When the pilot control valve 38 is opened, however, the line pressure may rapidly diminish as a result of pressure losses in the line between the compressor 13 and pilot control valve 38. This could be caused by obstructions in the air line. Therefore, the apparatus preferably uses a plurality of pressure gauges to monitor the line pressure while the pilot control valve 38 is open. For example, the inlet side of the pilot control valve 38 may comprise a pressure gauge to detect losses that occur prior to the control valve.

The desired pressure in the flexible enclosure 16 is often dependent on the size of the rigid enclosure 10 and the flexible enclosure 16 used. Enclosures having standard sizes may be associated with different pressure settings. Therefore, the apparatus preferably includes a pressure setting switch 52 operable to set the desired pressure in the flexible enclosure 16. In FIG. 1, the pressure setting switch is connected with the servomechanism 50. The switch 52 is operable in one or more pressure settings corresponding to desired pressure conditions or “pressure peaks” in the flexible enclosure 16. In this configuration, the servomechanism 50 controls the flow of air through the adjustable control valve 30 so that pressure in the flexible enclosure 16 is maintained at the preset pressure peak during pressurization of the flexible enclosure.

As stated earlier, the apparatus may be used to apply external pressure to a patient's arm, leg or other extremity. Flexible enclosures are manufactured in different standard sizes corresponding to different extremities. The proper operating pressure will vary depending on the size of the flexible enclosure used. Preferably, the pressure setting switch 52 has programmed settings corresponding to standard sized flexible enclosures. For example, the switch 52 may comprise a first setting operable to automatically provide 1.1 pounds per square inch (30 inches of water) for large enclosures, and a second setting operable to automatically provide 1.65 pounds per square inch (45 inches of water) for small enclosures. The switch may further provide a manual setting and dial to program other pressure settings.

The flexible enclosure 16 may be formed of any suitable flexible material, including a variety of plastics or other materials. Preferably, the flexible enclosure 16 is manufactured with a density and thickness rated for a specific maximum pressure limit. When pressure in the flexible enclosure 16 exceeds the maximum limit for air pressure, the flexible enclosure is configured to rupture and release pressure. This provides a safety feature to prevent dangerously high pressures from being applied to the patient's extremity. The material forming the flexible enclosure 16 is free of seams, folds or other abrupt features that could cause discomfort when pressed against a patient's extremity. Furthermore, the flexible enclosure 16 is preferably formed of a non-allergenic material to reduce the risk of adverse reactions in sensitive patients. The material selected to form the flexible enclosure 16 should be resistant to excessive collapse. As stated earlier, however, some degree of collapse may occur, and the adjustable control valve 30 is configured to account for collapse that may occur.

In the preferred embodiment, the piping and valves use low friction materials and are substantially free of abrupt transitions that contribute to pressure losses and reduced pressures in the flexible enclosure 16. Adjacent conduits and fittings are preferably of uniform diameter. Adjacent components having different sizes are preferably joined by reducers to provide smooth transitions.

The operation of the apparatus will now be described. Initially, the compressor is turned off, and the pilot control valve 38, adjustable control valve 30 and release valve 37 are closed. Since the release valve 37 is closed, the valve element 33 in the air outlet valve 32 is subject only to atmospheric pressure and the upward bias of the spring, which expands to move the valve element to the open position. In this position, the interior of the flexible enclosure 16 is open to the atmosphere in a depressurized condition.

After the patient's leg is placed in the flexible enclosure 16 in the rigid enclosure 10, the compressor is actuated to deliver compressed air into air line 36. The EKG monitor 40 begins monitoring the QRS complex associated with the patient's heartbeat. After the arterial pulse enters the leg, the EKG monitor 40 sends an electrical pulse to the solenoid 39 to open the pilot control valve 38. Compressed air passes through the pilot control valve 38 into connecting lines 41, 43. Connecting line 43 connects the pilot control valve 38 with the adjustable control valve 30, and connecting line 41 connects the pilot control valve with the release valve 37. Air passing through line 43 causes adjustable control valve 30 to open, and air passing through line 41 causes the release valve 37 to open. When the adjustable control valve 30 is opened, compressed air in air supply line 28 enters into the air inlet conduit 26 and flows into the flexible enclosure 16, beginning the inflation cycle. Simultaneously, the release valve 37 is opened, permitting compressed air to enter the chamber 34 in the air outlet valve 32 and move the valve element 33 to the closed position. When compressed air flows through line 36 and into the chamber 34, the valve element 33 is displaced downwardly against an O-ring 35 by the force of compressed air. The valve element is displaced against the bias of the spring to close off the connection between the air inlet conduit 26 and air outlet valve 32. In this arrangement, compressed air flows from the air supply conduit 28, through the air inlet conduit 26 and into the flexible enclosure 16. Air passing through the air inlet 26 inflates the flexible enclosure 16, compressing the patient's leg. With the air outlet valve 32 closed, air that enters the air inlet conduit 26 and the flexible enclosure 16 is not permitted to escape from the flexible enclosure during the inflation cycle.

Current from the EKG monitor 40 flows through the solenoid 39 for a brief amount of time before ceasing. Typically, the current flows through the solenoid 39 for a fraction of a second. When the current ceases, the solenoid 39 returns to its original position, closing the pilot control valve 38. Once the pilot control valve 38 is closed, the flow of compressed air to the adjustable control valve 30 and release valve 37 ceases. Pressure on the valve element 33 in air outlet valve 32 is removed, allowing the spring to open the air outlet valve to release pressure from the flexible enclosure 16. The air outlet valve 32 is a quick-opening valve, and the openings in the valve wall are large enough to permit a rapid release of pressure from the flexible enclosure 16. In this arrangement, pressure is released from the flexible enclosure 16 in a substantially instantaneous manner.

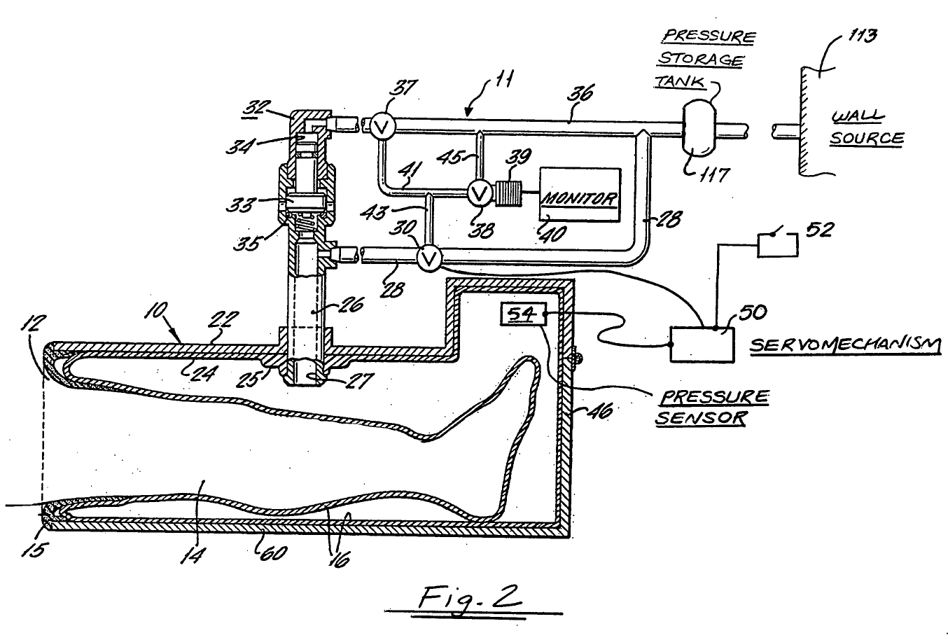

Referring now to FIG. 2, an alternate embodiment of an apparatus in accordance with the present invention is shown. The apparatus includes a rigid enclosure 10 and a flexible enclosure 16, as in the apparatus described in connection with FIG. 1. Compressed air is supplied by air line 36, which is connected to a wall source 113. A valve assembly 11 connects the wall source 113 with the flexible enclosure 16.

Wall sources can be advantageous in that they eliminate the need for a compressor unit, which occupies a considerable amount of space. In addition, wall sources create significantly less noise pollution than portable compressor units. Unfortunately, general-purpose wall sources and air hoses may not provide adequate pressure to rapidly inflate the flexible enclosure during an inflation cycle. As stated earlier, the cycle time for inflation is relatively short. As a result, the flexible enclosure 16 is fully inflated in a relatively short period of time by a rapid burst of compressed air. When a patient's pulse rate is 60, for example, there is one second between heart beats. The compression time (i.e. the time in which the pilot control valve is open to inflate the flexible enclosure during an inflation cycle) may be set to a fraction of this interval, for example 0.40 seconds. Constrictions and abrupt transitions associated with the wall source 113 can cause significant pressure losses as air travels from the wall source to the flexible enclosure. When the adjustable control valve 30 is closed, the line pressure prior to the adjustable control valve gradually builds to a desired operating pressure. When the adjustable control valve 30 is opened, however, the volume of compressed air in the air supply line 28 is exposed to a large pressure differential, causing the compressed air in the air supply line to rapidly exit into the flexible enclosure 16. Consequently, the line pressure prior to the adjustable control valve 30 may rapidly decrease to a pressure below the desired operating pressure when the adjustable control valve is opened. Constrictions in the wall source may prevent sufficient flow of compressed air to replenish the volume of air released from the air supply line 28. As a result, the wall source may not sustain a high enough line pressure to fully inflate the flexible enclosure 16 during an inflation cycle.

To sustain the flow of compressed air during an inflation cycle, the apparatus preferably includes a pressure storage tank 117 connected between the wall source 113 and the air supply line 28. The pressure storage tank 117 is configured to store a volume of compressed air and provide a reserve of compressed air at a desired operating pressure. The storage tank 117 may be connected at various points between the wall source 113 and rigid enclosure 10. Preferably, the storage tank 117 is connected as close as possible to the air supply line 28. In this way, the gradual loss of pressure that occurs when the compressed air travels between the storage tank 117 and the air supply line 28 is minimized.

Referring to FIG. 2, the storage tank 117 has an inlet connected to the wall source 113 and an outlet connected to the air line 36 in the valve assembly 11. The storage tank 117 receives a constant flow of compressed air from the wall source 113 through the inlet of the storage tank. In contrast, compressed air is released from the storage tank 117 only during the brief amount of time that the pilot control valve 38 is open. Therefore, the time ratio of inflow to outflow from the storage tank is significantly greater than 1.0, resulting in the accumulation of back pressure in the storage tank. By maintaining a relatively large volume of compressed air at or near operating pressure in the storage tank 117, a high flow rate of compressed air can be sustained throughout each inflation cycle. Since the tank 117 is located on the discharge side of the wall source 113, the flow of compressed air from the tank is not affected by constrictions or obstructions present in the wall source and/or lines connected to the wall source. The size and volume of the pressure storage tank is preferably large in comparison to the volume of compressed air supplied during each inflation cycle. In this way, the drop in pressure in the storage tank during an inflation cycle is insignificant. A 5-10 gallon pressure storage tank 117 provides adequate volume to maintain adequate pressure in the valve assembly throughout each inflation cycle.

The terms and expressions which have been employed are used as terms of description and not of limitation. There is no intention in the use of such terms and expressions of excluding any equivalents of the features shown and described or portions thereof. It is recognized, therefore, that various modifications are possible within the scope and spirit of the invention. Accordingly, the invention incorporates variations that fall within the scope of the following claims.

1. An apparatus for improving circulation of blood in a patient's extremity, comprising:
A. a rigid enclosure adapted to enclose the patient's extremity, said enclosure comprising an opening adapted to receive the patient's extremity into the rigid enclosure;
B. a flexible enclosure within the rigid enclosure, said flexible enclosure configured to extend circumferentially around the patient's extremity when the extremity is inserted into the rigid enclosure;
C. a source of compressed gas connected with the flexible enclosure, said source of compressed gas being operable to discharge gas and inflate the flexible enclosure with the gas;
D. a pilot control valve connected between the source of compressed gas and the flexible enclosure, said pilot control valve operable in an open position to permit the flow of gas into the flexible enclosure, and a closed position to prevent the flow of gas into the flexible enclosure;
E. a monitor operably connected with the pilot control valve, said monitor being operable to detect the patient's arterial pulse and open the pilot control valve in response to detection of said arterial pulse;
F. an adjustable control valve connected between the pilot control valve and the flexible enclosure, said adjustable control valve being operable to regulate the flow of gas into the flexible enclosure; and
G. a pressure sensor operably connected with the plastic enclosure and adjustable control valve, said pressure sensor operable to measure the pressure in the flexible enclosure and adjust the flow of compressed gas into the flexible enclosure in response to the pressure measured in the flexible enclosure.

2. The apparatus of claim 1, wherein the monitor comprises a computerized EKG monitor.

3. The apparatus of claim 1, wherein the compressed gas is air, and the source of compressed gas comprises an air compressor operable to pump air into the flexible enclosure.

4. The apparatus of claim 3, wherein the pressure sensor is operably connected with the air compressor to adjust the flow of compressed air from the air compressor into the flexible enclosure.

5. The apparatus of claim 1, comprising a pressure storage tank between the source of compressed gas and the flexible enclosure.

6. An apparatus for use with a source of compressed gas to improve the circulation of blood in a patient's extremity, said apparatus comprising:
A. a rigid enclosure adapted to enclose the patient's extremity, said enclosure comprising an opening adapted to receive the patient's extremity into the rigid enclosure;
B. a flexible enclosure within the rigid enclosure, said flexible enclosure configured to extend circumferentially around the patient's extremity when the extremity is inserted into the rigid enclosure;
C. a valve assembly configured for connection between the source of compressed gas and the flexible enclosure, said valve assembly operable in an open setting to permit the flow of gas from the source of compressed gas into the flexible enclosure, and a closed setting to prevent the flow of gas from the source of compressed gas into the flexible enclosure;
D. a monitor operably connected with the valve assembly, said monitor being configured to detect the patient's arterial pulse and switch the valve assembly to the open setting in response to detection of said arterial pulse; and
E. a pressure storage tank connected between the source of compressed gas and the valve assembly, said pressure storage tank having an inlet connected with the source of compressed gas and an outlet connected with the valve assembly.

7. The apparatus of claim 6, wherein the monitor comprises a computerized EKG monitor.

8. An apparatus for improving circulation of blood in a patient's extremity, comprising:
A. a rigid enclosure adapted to enclose the patient's extremity, said enclosure comprising an opening adapted to receive the patient's extremity into the rigid enclosure;
B. a flexible enclosure within the rigid enclosure, said flexible enclosure configured to extend circumferentially around the patient's extremity when the extremity is inserted into the rigid enclosure;
C. a source of compressed gas connected with the flexible enclosure, said source of compressed gas being operable to discharge gas and inflate the flexible enclosure with the gas;
D. a pilot control valve connected between the source of compressed gas and the flexible enclosure, said pilot control valve operable in an open position to permit the flow of gas into the flexible enclosure, and a closed position to prevent the flow of gas into the flexible enclosure;
E. a monitor operably connected with the pilot control valve, said monitor being operable to detect the patient's arterial pulse and open the pilot control valve in response to detection of said pulse;
F. an adjustable control valve connected between the pilot control valve and the flexible enclosure, said adjustable control valve being adjustable to regulate the flow of compressed gas into the flexible enclosure; and
G. a pressure storage tank connected between the source of compressed gas and the flexible enclosure.

9. The apparatus of claim 8, wherein the monitor comprises a computerized EKG monitor.

10. The apparatus of claim 8, comprising a valve stem extending from the adjustable control valve for manually regulating the flow of compressed gas into the flexible enclosure.

11. The apparatus of claim 8, comprising a pressure sensor configured for measuring the pressure in the flexible enclosure, said pressure sensor being operably connected with the adjustable control valve to adjust the flow of compressed gas into the flexible enclosure in response to the pressure measured in the flexible enclosure.

12. The apparatus of claim 11, comprising a servomechanism operably connected with the pressure sensor and the adjustable control valve, said servomechanism being operable to increase the flow of compressed gas through the adjustable control valve when the measured pressure in the flexible enclosure falls below a minimum pressure, and to decrease the flow of compressed gas through the adjustable control valve when the measured pressure in the flexible enclosure exceeds a maximum pressure.

13. The apparatus of claim 8, comprising an air outlet valve connected with the flexible enclosure, said air outlet valve being operable in a sealed position to substantially prevent the release of gas from the flexible enclosure, and an unsealed position to permit the release of gas from the flexible enclosure.

14. A method for enhancing circulation in a patient's extremity, comprising the steps of:
A. placing the extremity in a flexible enclosure adapted to surround the extremity;
B. connecting the flexible enclosure to a source of compressed gas, said source of compressed gas being operable to inflate the flexible enclosure with gas to create an internal pressure in the flexible enclosure and apply external pressure to the patient's extremity;
C. monitoring the patient's arterial pulse to detect the arrival of the arterial pulse into the extremity;
D. inflating the flexible enclosure with gas to apply external pressure to the extremity after the arrival of the arterial pulse into the extremity;
E. releasing gas from the flexible enclosure to remove external pressure from the patient's extremity;
F. measuring the internal pressure in the flexible enclosure as external pressure is applied to and removed from the patient's extremity; and
G. automatically adjusting the flow of gas into the flexible enclosure in response to the measured internal pressure in the flexible enclosure to maintain the internal pressure within a preferred pressure range.

15. The method of claim 14, wherein the step of automatically adjusting the flow of gas into the flexible enclosure comprises:
A. sending an input signal to a servomechanism when the internal pressure in the flexible enclosure falls outside the preferred pressure range; and
B. sending an output signal from the servomechanism to an adjustable control valve operable to regulate the flow of gas into the flexible enclosure.
